(19) United States
(12) Patent Application Publication
(10) Pub. No.: US 2008/0006363 A1
(43) Pub. Date: Jan. 10, 2008

(54) Spatter coat urethane roofing adhesives and their application

(76) Inventors: Terri S. Townsend, Ashland, OH (US); William R. Gareis, Mars, PA (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/481,033

(22) Filed: Jul. 5, 2006

(51) Int. Cl. E04F 13/00; B32B 37/12; C09J 101/00

(52) U.S. Cl. 156/71; 156/331.7

(57) ABSTRACT

Roofing insulation and roofing elastomeric membranes are secured with a moisture-curable urethane roofing adhesive composition by spatter applying the roofing adhesive composition at an application rate of between about 10 and about 18 grams per square foot. Spatter application of the adhesive diminishes show-through (aesthetics) of the cured adhesive, while providing superior performance.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention generally relates to roofing adhesives and more particularly to a spatter coat application method for urethane roofing adhesives.

Elastomeric roofing membrane specifications often dictate that the roofing adhesive completely coat the membrane back in order to meet performance criteria under wind conditions (i.e., wind uplift resistance, etc.). Urethane roofing adhesives, for example, typically are applied by one of three techniques: bead application, spray application, or trowel application. Each of these techniques has various deficiencies that need to be addressed by the roofing contractor.

A major drawback with bead and ribbon application is aesthetics, especially when elastomeric membranes are used. The impression of the adhesive bead pattern (known as “telegraphing”) is clearly visible through the membrane. Roofing contractors assume that the lack of complete coverage means that performance will be adversely impacted. While this is not necessarily true, the adhesive show-through aesthetics militate against its use.

Spay application permits complete coverage and show-through of the applied adhesive is not an issue; however, spraying of urethane adhesives can cause potential health risks due to the atomization of polymeric methylene diisocyanate (pMDI), an often used component in commercial urethane formulations. In addition the risk of overspray is a concern when spraying adhesives on rooftop applications.

Application of adhesives by troweling requires a significant amount of labor, which increases its cost. Moreover, a longer application time is experienced and show-through of the trowel-applied adhesive still is an issue.

### BRIEF SUMMARY OF THE INVENTION

It has been unexpected discovered that spatter coating of roofing adhesives does not suffer from overspray and atomization issues prevalent in conventional spray application techniques. Even though spatter applied adhesives are not continuous, rigid elastomeric roofing requirements still can be met. The use of spatter applied roofing adhesives, then, unexpectedly addresses aesthetic concerns that roofing contractors associate with a sub-standard adhesive application; yet, spatter applied roofing adhesives in fact meet the rigid roofing membrane performance requirements, as demonstrated in the working examples herein.

Roofing insulation and roofing elastomeric membranes, then, are secured with a moisture-curable urethane roofing adhesive composition by spatter applying the roofing adhesive composition at an application rate of between about 10 and about 18 grams per square foot. The spatter coat system can be used for one or two part moisture-curable urethane roofing adhesive compositions. Spatter coat applicators can be mounted on portable units or larger stationary units.

Advantages of the present invention include improved aesthetics of the membrane with retention of required performance of the elastomeric membrane. Another advantage is the ability to achieve fast cure times. Yet another advantage is the low labor requirement. These and other advantages will be readily apparent to the skilled artisan based on the disclosure set forth herein.

### DETAILED DESCRIPTION OF THE INVENTION

Spatter coat adhesive applicators can be used to advantagae to apply urethane/cellular roofing adhesives in accordance with the disclosure set forth herein. “Spatter coating”, for present purposes, comprehends a unique method of applying liquid materials in a low overspread conical pattern using fine strands and/or globules of the material that are ejected from the nozzle in an irregular pattern at relatively high speeds without the generation of small aerosol particles which are typically generated in sprays. This method of application essentially eliminates airborne aerosol particles common with sprays. This technique also eliminates aesthetic issues associated with bead applied systems. Spatter coating greatly minimizes the health issues associated with the exposure to atomized pMDI typical in spraying applications. The risk of overspray also is greatly reduced. Compared to using a trowel to apply adhesive, spatter coating allows for a given area of roof to have adhesive applied more quickly with less labor.

Spatter coating urethane roofing adhesives can allow for the adhesive to be applied in fine strands. These fine strands provide two significant benefits with urethane adhesives: better adhesive coverage rates and faster cure times. The fine strands of adhesive applied by a spattering system allow for significantly lower adhesive application rates. The fine strands of adhesive yield more surface area per volume of adhesive compared to thick bead applications. Application rates of about 13 grams/square foot have been demonstrated with a spattering system, while application rates of 19 grams/square foot are required for the same substrates when the adhesive is applied in thick beads.

The fine strands also permit urethane adhesives to cure faster. The fine strands of adhesive yield greater surface area per a given volume of adhesive compared to other spray application methods. The greater surface area allows for more adhesive to come in contact with moisture in the air and in the substrates to be bonded. This exposure to moisture causes the adhesive to cure faster than it cures using bead application. The spatter system gives great diversity in adhesive coverage rates. For example, based on the roofing substrates used, i.e., isocyanuarate, wood fiber, gypsum board, coverage rates can vary from about 10 to about 18 grams per square foot. The broadest range of application rates for roofing adhesive by spatter coating typically ranges from about 5 to about 25 grams per square foot.

Typical roof configurations include a roof deck, one or more insulating layers, and an elastomeric membrane. Roof decks often are formed from concrete, lightweight concrete, or metal. Insulating layers can be formed from isocyanurate board, wood fiber, plywood, oriented stand board (OSB), gypsum board, perlite, tectum, and various other substrates. Multiple insulating layers of the same or different materials can be used. Each such insulating layer is adhered in place with a moisture curable polyurethane adhesive utilizing the spatter coat application method disclosed herein.

The final component of the roofing system is the elastomeric membrane which covers the roof deck and insulating layer or layers. Suitable elastomeric membranes can be formed from ethylene propylene diene monomer (EPDMs), polyvinyl chloride (PVC), or a thermoplastic polyolefin type membrane. The adhesive is spatter applied to the roofing substrate before rolling in the single ply roofing membrane.

Isocyanate-functional prepolymers are made from polyisocyanates reacted with a compound containing active hydrogen functionality with hydroxyl groups being typical, although mercaptan groups, amine groups, and carboxyl groups also can be used. Polyisocyanates are conventional in nature and include, for example, hexamethylene diisocyanate, toluene diisocyanate (TDI), diphenylmethane diisocyanate (MDI), m- and p-phenylene diisocyanates, bitolylene diisocyanate, cyclohexane diisocyanate (CHDI), bis-(isocyanatomethyl) cyclohexane (H₆XDI), dicyclohexylmethane diisocyanate (H₁₂MDI), dimer acid diisocyanate (DDI), trimethyl hexamethylene diisocyanate, lysine diisocyanate and its methyl ester, isophorone diisocyanate, methyl cyclohexane diisocyanate, 1,5-napthalene diisocyanate, xylylene and xylene diisocyanate and methyl derivatives thereof, polymethylene polyphenyl isocyanates, chlorophenylene-2,4-diisocyanate, polyphenylene diisocyanates available commercially as, for example, Mondur MR or Mondur MRS, isophorone diisocyanate (IPDI), hydrogenated methylene diphenyl isocyanate (HMDI), tetramethyl xylene diisocyanate (TMXDI), hexamethylene diisocyanate (HDI), or oligomer materials of these materials such as a trimer of IPDI, HDI or a biuret of HDI, and the like and mixtures thereof. Triisocyanates and high-functional isocyanates also are well known and can be used to advantage. Aromatic and aliphatic diisocyanates, for example, (including biuret and isocyanurate derivatives) often are available as pre-formed commercial packages and can be used to advantage in the present invention.

Preferred polyols for reacting with the polyisocyanates include, for example, polyether polyols (e.g., block polyethylene and polypropylene oxide homo- and co-polymers ranging in molecular weight from about 300 to about 3,000) optionally alkylated (e.g., polytetramethylene ether glycols), caprolactone-based polyols, and the like. However, the component also may be formulated with mixtures of aliphatic and aromatic polyols, or a multi-functional, active hydrogen-bearing polymer. Thus, in addition to polyether polyols, the hydroxyl-functional component may include derivatives of acrylates, esters, vinyls, castor oils, as well as polymers and mixtures thereof.

Isocyanate equivalents should predominate over active hydrogen equivalents in the polyisocyanate/polyol reaction mixture in order for the resulting prepolymer to contain residual isocyanate groups for moisture curing. Reaction conditions for this reaction are well known in the art, such as described by Heiss, et al., “Influence of Acids and Bases on Preparation of Urethane Polymers”, Industrial and Engineering Chemistry, Vol. 51, No. 8, August 1959, pp. 929-934. Depending upon the reaction conditions used (such as, for example, temperature and the presence of strong acids or bases, and catalysts), the reaction may lead to the formation of ureas, allophanates, biurets, or isocyanates.

The following example shows how the present invention has been practiced, but should not be construed as a limitation of the invention. In this application all units are in the metric system and all amounts and percentages are by weight, unless otherwise expressly indicated.

### EXAMPLE

Spatter coat application was used to apply a one-part moisture curable urethane adhesive to bond insulation board to roof deck. The adhesive composition used was PLIODECK® membrane adhesive (light amber color, 100% solids, 4000-10000 cps Brookfield RVT Spindle No. 5 at 10 rpm viscosity, 1.160 specific gravity, 13.0-13.8% free NCO, 05 VOC's, Ashland Specialty Polymers & Adhesives, Columbus, Ohio). Testing was conducted in accordance with Factory Mutual Research J.I. 1B3A0.AM, Standard 4470 (1996). An AST spatter equipment Model Number FGMP.075×5/Serial 4248 (Adhesive System Technology Corporation, New Hope, Minn.) was used to apply the adhesive composition. The aesthetics of the bonded membrane were similar to a fully adhered roof. That is, there was no visible evidence that the membrane was not completely coated with the urethane adhesive.

Two 5′×9′ roof decks were built to test wind uplift resistance. The first deck was built with the standard coat weight of 19 grams of adhesive per square foot and, when tested, achieved a wind uplift rating of 1-90 with the Isocyanurate board fracturing during the testing. The second deck was built using a lighter coat weight of 13 grams per square foot and, when tested, achieved a wind uplift rating of 1-105 (105 pounds per square foot). Isocyanurate board fracturing during the testing.

When testing a 5′×9′ deck the maximum uplift rating that can be achieved is a 1-90 (90 pounds per square foot), even if the actual number is higher than 90.

While the invention has been described with reference to various embodiments, those skilled in the art will understand that various changes may be made and equivalents may be substituted for elements thereof without departing would had it been bead applied. The spatter system gives great diversity in adhesive coverage rates, and based on from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the metric system and all amounts and percentages are by weight, unless otherwise expressly indicated. Also, all citations referred herein are expressly incorporated herein by reference.

We claim:

1. In a method for securing roofing insulation and roofing elastomeric membranes with a moisture-curable urethane roofing adhesive composition, the improvement for diminishing show-through of the adhesive while maintaining performance, which comprises:
spatter applying said roofing adhesive composition at an application rate of between about 10 and about 18 grams per square foot.

2. The method of claim 1, wherein moisture-curable urethane adhesive composition is formulated from an isocyanate component being one or more of hexamethylene diisocyanate, toluene diisocyanate (TDI), diphenylmethane diisocyanate (MDI), m- and p-phenylene diisocyanates, bitolylene diisocyanate, cyclohexane diisocyanate (CHDI), bis-(isocyanatomethyl) cyclohexane (H₆XDI), dicyclohexylmethane diisocyanate (H₁₂MDI), dimer acid diisocyanate (DDI), trimethyl hexamethylene diisocyanate, lysine diisocyanate and its methyl ester, isophorone diisocyanate, methyl cyclohexane diisocyanate, 1,5-napthalene diisocyanate, xylylene and xylene diisocyanate and methyl derivatives thereof, polymethylene polyphenyl isocyanates, chlorophenylene-2,4-diisocyanate, polyphenylene diisocyanates, isophorone diisocyanate (IPDI), hydrogenated methylene diphenyl isocyanate (HMDI), tetramethyl xylene diisocyanate (TMXDI), or hexamethylene diisocyanate (HDI).

3. The method of claim 1, wherein said roofing insulation comprises one or more layers of one or more of isocyanurate board, wood fiber, plywood, oriented stand board (OSB), gypsum board, perlite, or tectum.

4. The method of claim 1, wherein roofing elastomeric membrane is one or more layers of one or more of ethylene propylene diene monomer (EPDMs), polyvinyl chloride (PVC), or a thermoplastic polyolefin.

5. The method of claim 4, wherein roofing elastomeric membrane is one or more layers of one or more of ethylene propylene diene monomer (EPDMs), polyvinyl chloride (PVC), or a thermoplastic polyolefin.
